(19) United States
(12) Patent Application Publication
(10) Pub. No.: US 2007/0066312 A1
(43) Pub. Date: Mar. 22, 2007

(54) Mobile ad hoc network system

(75) Inventors: Yusuke Shomura, Kokubunji (JP); Junji Yamamoto, Tokyo (JP); Satoshi Yoshizawa, Musashino (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/487,309

(22) Filed: Jul. 17, 2006

(30) Foreign Application Priority Data
Sep. 6, 2005 (JP) 2005-257243

(51) Int. Cl. H04Q 7/20

(52) U.S. Cl. 455/445

(57) ABSTRACT

In ad hoc systems using OLSR, when a mobile node moves out of the fixed node's communication area, communication is impossible in the period from leaving the communication area until the time-out, even if there is a node to relay communications between the fixed node and mobile node. Switching from direct communication to 2-hop communication without interruption is therefore important for achieving continuous communication. Each node reports its position information and speed information to a neighbor mode. The fixed node compares that information with its own communication area, detects mobile node movement to outside the communication area from the mobile node's position and speed information, and switches beforehand to 2-hop communication via a relay node.

### CLAIM OF PRIORITY

The present application claims priority from Japanese application JP 2005-257243 filed on Sep. 6, 2005, the content of which is hereby incorporated by reference into this application.

### FIELD OF THE INVENTION

This invention relates to an ad hoc network system, and relates in particular to a method for selecting the optimal communication path for a mobile node and a fixed node in communication systems using OLSR.

### BACKGROUND OF THE INVENTION

In the optimized link state routing protocol (OLSR) under evaluation by the IETF, the nodes periodically exchange Hello messages including a list of nodes capable of direct communication between nodes. The Hello messages allow acquiring information from neighbor terminals and making an ad hoc network.

[Non-patent document 1] RFC3626, Optimized Link State Routing Protocol (OLSR), October 2003

### SUMMARY OF THE INVENTION

In OLSR, each node forms a communication path to a neighbor node based on information in the Hello message. When a Hello message from a node capable of direct communication does not arrive within a fixed time (time-out time), then direct communication is judged impossible with that node and the communication path is changed. So when the mobile node moves outside the fixed node communication area, during communication between a fixed node and a mobile node, communication then becomes impossible in the period between leaving the communication area up to the time-out, even if a node is available to relay communications between the fixed terminal and the relay terminal.

The object of this invention is to provide a method to avoid a communication cutoff from occurring when switching from direct communication to 2-hop communication, in communication by OLSR between a fixed node and a mobile node.

To achieve the above object, each node acquired position information and speed information and reports to a neighbor node. The fixed node compares that information with its own communication area, detects mobile node movement to outside the communication area beforehand from the mobile node's position and speed information, and switches to 2-hop communication via the relay node.

This invention is therefore capable of switching from direct communication to 2-hop communication with no cutoffs or interruptions in communication when the mobile node moves outside the fixed node communication area during communication between the fixed node and the mobile node.

### BRIEF DESCRIPTION OF THE DRAWINGS

FIG. 1 is a concept diagram of the network of this invention;

FIG. 2 is a block diagram showing the internal structure of the base station utilized in this invention;

FIG. 3 is a block diagram showing the internal structure of the node utilized in this invention;

FIG. 4 is a table showing the structure of the neighbor node list;

FIG. 5 is a flow chart for describing the OLSR message processing;

FIG. 6 is a flow chart for describing the communication path forming process;

FIG. 7 is a sequence diagram for describing the states in this invention;

FIG. 8 is a format drawing of the Hello packet with position•speed information attached;

FIG. 9 is a table for showing the structure of the Hello message receive history;

FIG. 10 is a flow chart describing the process for forming the Hello message receive history;

FIG. 11 is a flow chart for describing the process for forming the radio wave map;

FIG. 12 is a concept drawing showing the radio wave map segmented into a lattice per the radiation contour.

### DETAILED DESCRIPTION OF THE PREFERRED EMBODIMENTS

The embodiment of this invention is hereafter described while referring to the accompanying drawings.

### First Embodiment

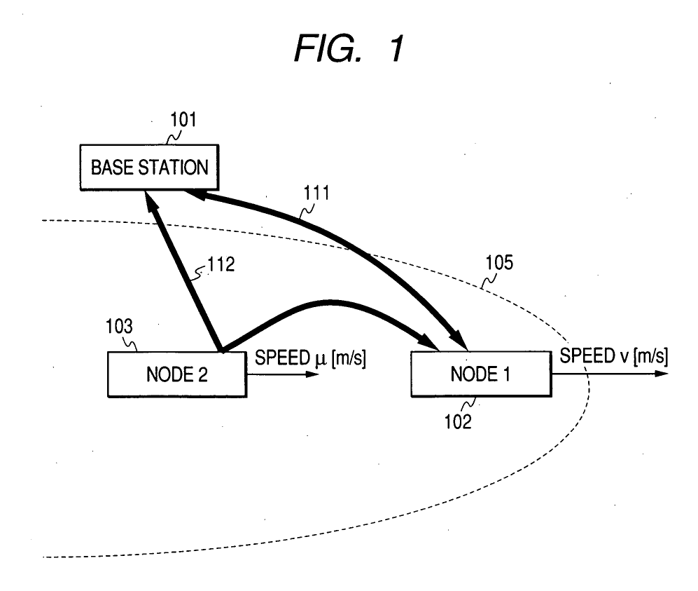

FIG. 1 is a concept diagram showing the structure of the ad hoc system of this invention. The system shown in FIG. 1 is made up of a base station 101, and mobile nodes 102, 103. The base station 101, and the mobile nodes 102, 103 mutually connected to each other utilizing Optimized Link State Routing Protocol. In the example in FIG. 1, the base station 101 and the node 102 carry out two-way (bidirectional) communication. The node 102 carries out direct communication 111 when within the communication-capable area 105 of base station 101. However when the node 102 moves out of the communication-capable area 105, the base station 101 switches via the node 103 to 2-hop communication.

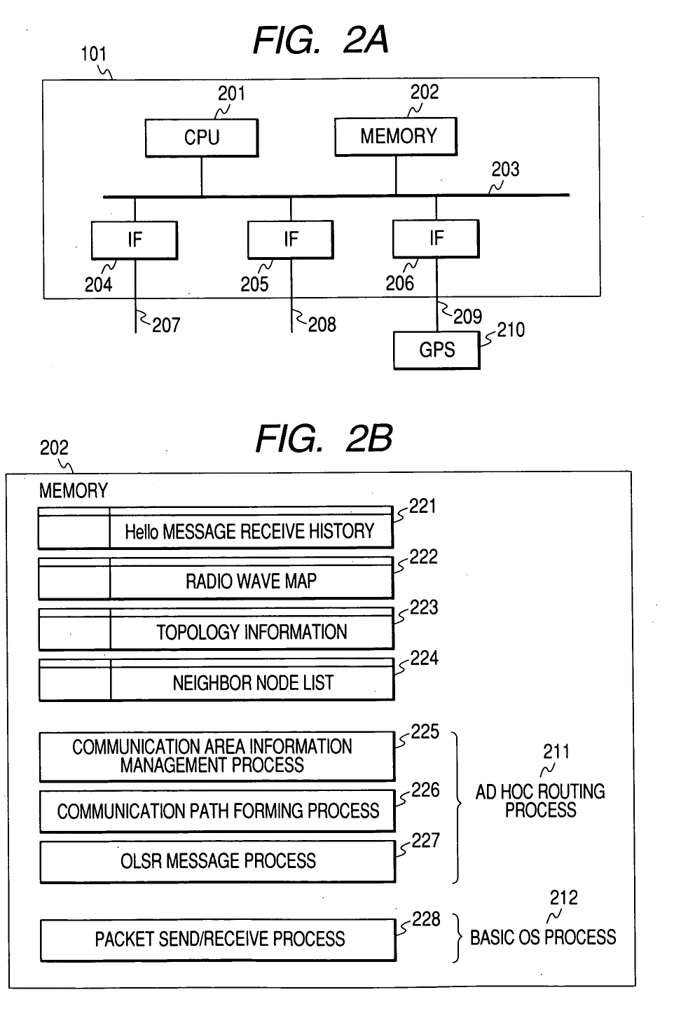

FIG. 2A is a block diagram showing the base station 101. A CPU (central processing unit) 201 executes various types of actual application programs and the OS (operating system). Programs executed by the CPU and different types of application programs are stored in the memory 202. A bus 203 connects the CPU201 and the memory 202. The interface units 204, 205, and 206 contain the lines 207, 208, 209 for communicating with other devices. The interface units 204, 205, and 206 output data supplied from the CPU201 and memory 202, to external devices; and supply data supplied from external devices to the CPU201 and the memory 202. A GPS (global positioning system) 210 is a system for utilizing information received from the GPS satellite, to calculated the latitude and longitude of the current site (location) of the user. The GPS outputs the calculated position information on the current location to the line 209. The base station 101 is a fixed node (terminal) so that position entry such as by manual input to the GPS210 can be omitted.

FIG. 2B is a functional block diagram of the base station 101. The memory 202 includes an ad hoc routing process 211 in addition to the basic OS process 212. The basic OS process 212 includes the packet send/receive process 228 which sends and receives IP packets.

The ad hoc routing process 211 includes an OLSR message process 227 for processing OSLR messages such as Hello messages, a communication path forming process 226 for forming communication paths from information obtained in OLSR messages, and a communication area information management process 225 for finding the region capable of communication with the base station 101.

The OLSR message process 227 handles processing of OSLR messages such as Hello message, TC message, MID message, and HNA message.

The neighbor node list 224 and the topology information 223 manage the processing results from the OLSR message process 227. The neighbor node list 224 manages information on neighboring terminals obtained via the Hello message, and the topology information 223 manages the information obtained from the TC message, etc.

The radio wave map 222 expresses the region capable of direct communication where its own terminal and radio waves can reach, and the Hello message receive history 221 holds Hello message information that was received from the mobile node.

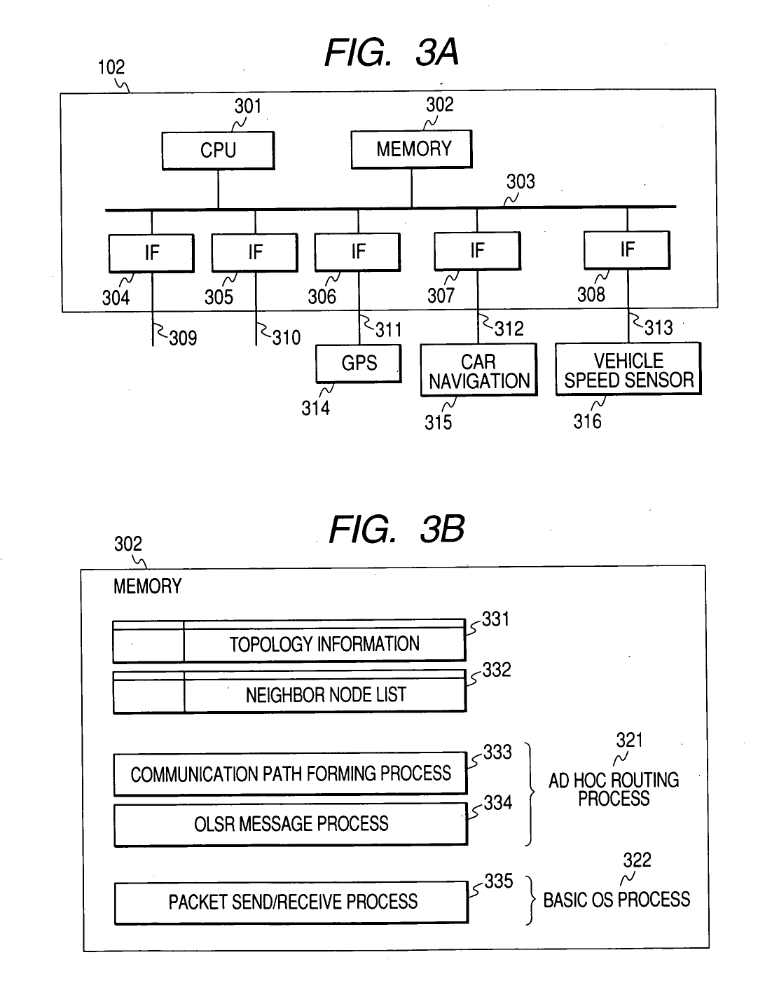

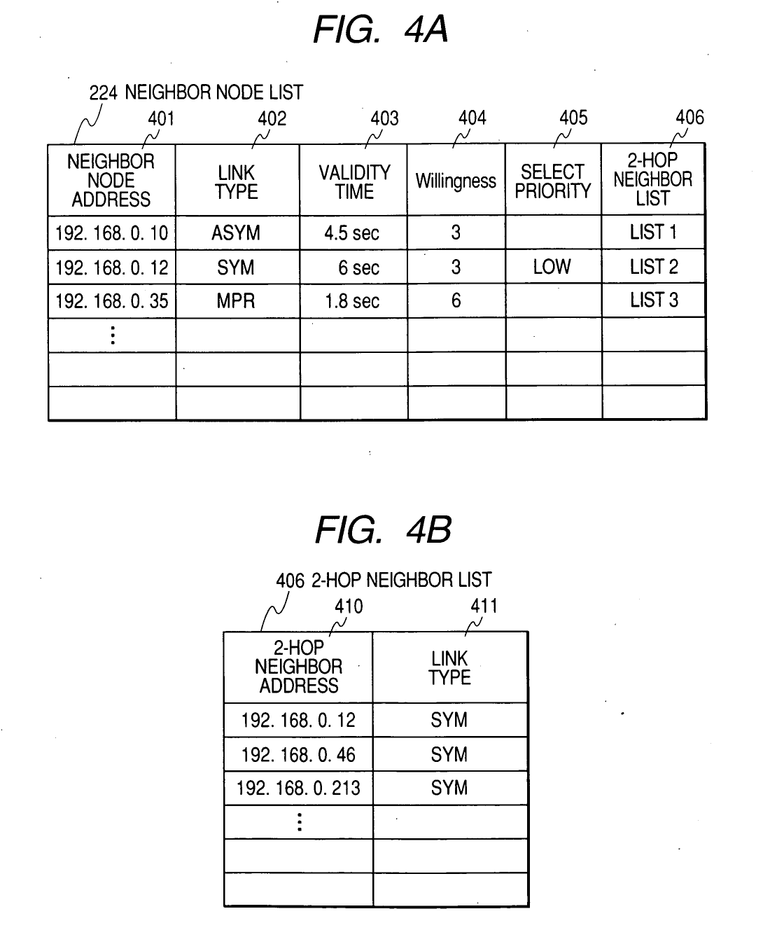

FIG. 3A is a block diagram of the nodes 102, 103. This structure includes a vehicle speed sensor 316 in addition to the base station 101 structure. Also, position information may be input from a car navigation unit 315 instead of the GPS314. FIG. 3B is a drawing showing the functional block diagram of the nodes 102, 103. The memory 302 contains a basic OS process 322 and an ad hoc routing process 321, the same as the base station. In this structure, the communication area information management block 225, the Hello message receive history 221, and the radio wave map 222 are omitted assuming movement. FIG. 4A shows an example of the neighbor node list. The neighbor node list includes an neighbor node address 401 expressing the address of nodes where radio waves can directly reach, a link type 402 for expressing the connection relation with its own node, an effective period 403 for expressing the time that the link type is effective, a Willingness 404 to report the node with the Hello message, a select priority 405 for expressing the priority of the path forming time, and a 2-Hop terminal list 406 for expressing node information on the connecting to neighbor terminals. The 2-hop terminal list 406 includes a 2-Hop terminal address 410 for connecting to the neighbor nodes, and a link type 411 for expressing the link type (connection state) of the 2-hop node with the neighbor node. The description of the link type 402 and the Willingness 404 is the same as described in RFC3626, Optimized Link State Routing Protocol (OLSR), October 2003.

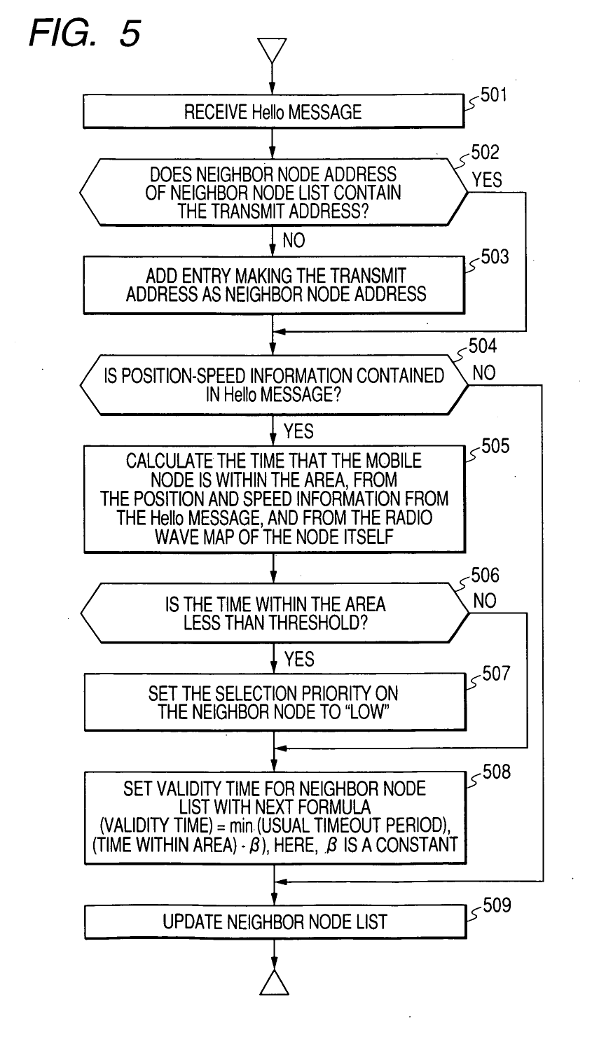

FIG. 5 shows the processing flow when the Hello message of OLSR message process 229 was received. When the Hello message is received (step 501), a search is made of neighbor addresses on the neighbor node list for the address of the transmitted Hello message (step 502). If not within the list, then that transmitted address is added as an entry to the neighbor node address (step 503). Next, a check is made within the Hello message for position and speed information (step 504), and if there is no position and speed information then the neighbor node list is rewritten (step 509) the same as for the usual OLSR terminal. The time that the terminal is within the area is then calculated (step 505) from the position•speed information obtained from the Hello message, and from the radio wave map of the terminal itself. If the time within the area is longer than a specified threshold then a validity time is set for the neighbor node list based on the time within the area (step 509). If the time within the area is shorter than the threshold then the “Select Priority” 405 is set to “Low” (step 507) per neighbor node list 224, and the validity time is set for the neighbor node list based on the time within the area (step 508), and the neighbor node list is rewritten (step 509).

The communication path forming process 226 is utilized to change the neighbor node list 224 and the topology information 223.

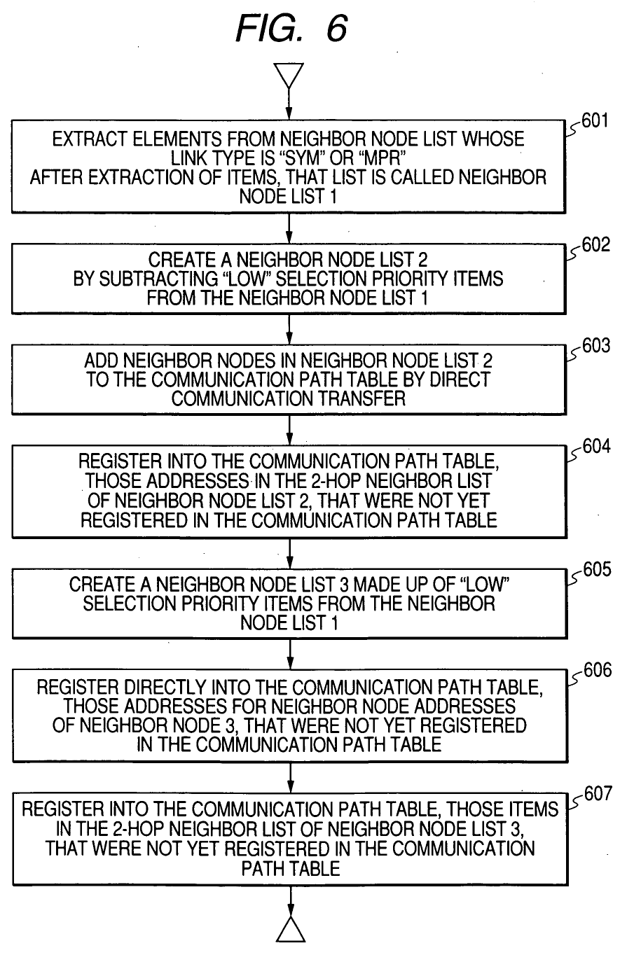

FIG. 6 shows the process flow for forming the communication paths from the neighbor node list in the communication path forming process 226. The communication process 226 first of all forms a neighbor node list 1 (step 601) by extracting the communication state SYM or MPR elements from the neighbor node list. The communication process 226 also forms a neighbor node list 2 (step 602) by removing “low” selection priority elements from the neighbor list 1. The process then adds the neighbor nodes of neighbor node list 2 to the communication path table via direct communication (step 603); and registers (the unregistered) addresses on the 2-hop node list of neighbor node list 2 onto the communication path table (step 604). In that case, neighbor node addresses including addresses matching those on the 2-hop node list are registered as the next hop address. The process next forms a neighbor node list 3 made up of “low” selection priority elements from the neighbor node list 1 (step 605). Neighbor node addresses on neighbor node list 3 not registered in the communication path table are registered as direct communication into the communication path table (step 606). Addresses in the 2-hop node list of neighbor node list 3 that are not registered in the communication path table are then registered into the communication path table (step 607). In that case, the next hop address on the communication path to the neighbor node containing an address matching that in the 2-hop node list is registered into the next hop address. If the communication path to the neighbor node is direct communication, then the next hop address is set as the neighbor node address.

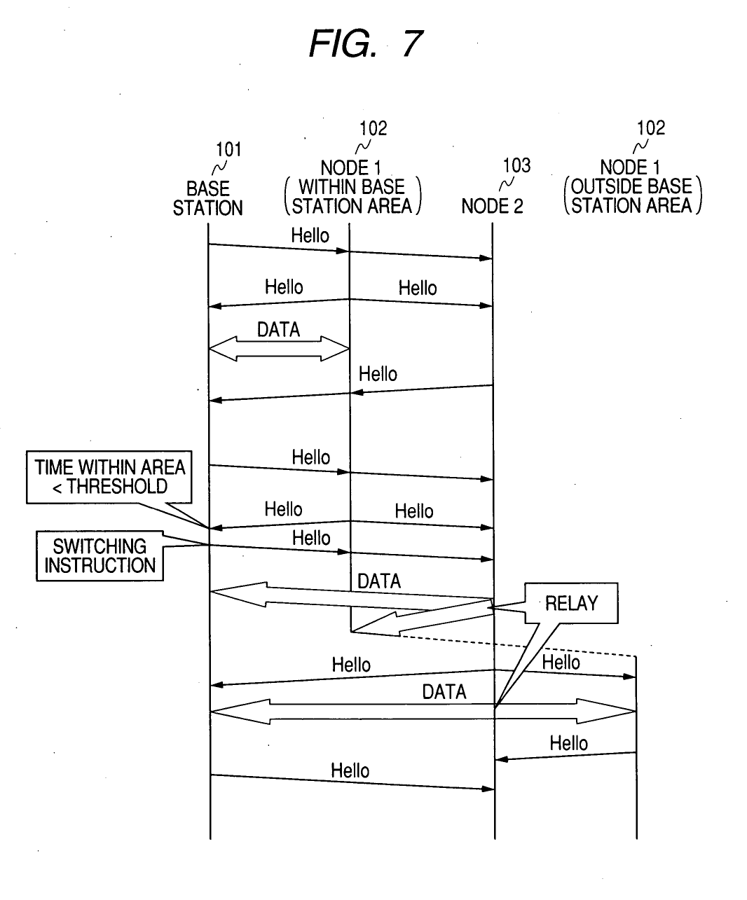

FIG. 7 is a diagram showing the communication sequence when the node 102 is moving out of the base station 101 communication area. The node 102 and the base station exchange Hello messages and carry out direct communication. The base station 101 calculates the time the node 102 is within the area from the node 102 position and speed information and if the time within the area is lower than the threshold value, switches to communication via the node 103. The base station 101 simultaneously instructs the node 102 to switch communication paths. When the base station judges from communication with the node 102 that time within the area was smaller than the threshold value, it can promptly switch to communication via the node 103. Communication is also switched from node 102 to the base station 101, when notification is received from the base station or when communication from the base station 101 via the node 103 was detected. The instruction from the base station 101 to the node 102 to switch the communication path can be given (notified) by deleting the node 102 address from the neighbor node list per the Hello message and sending the Hello message.

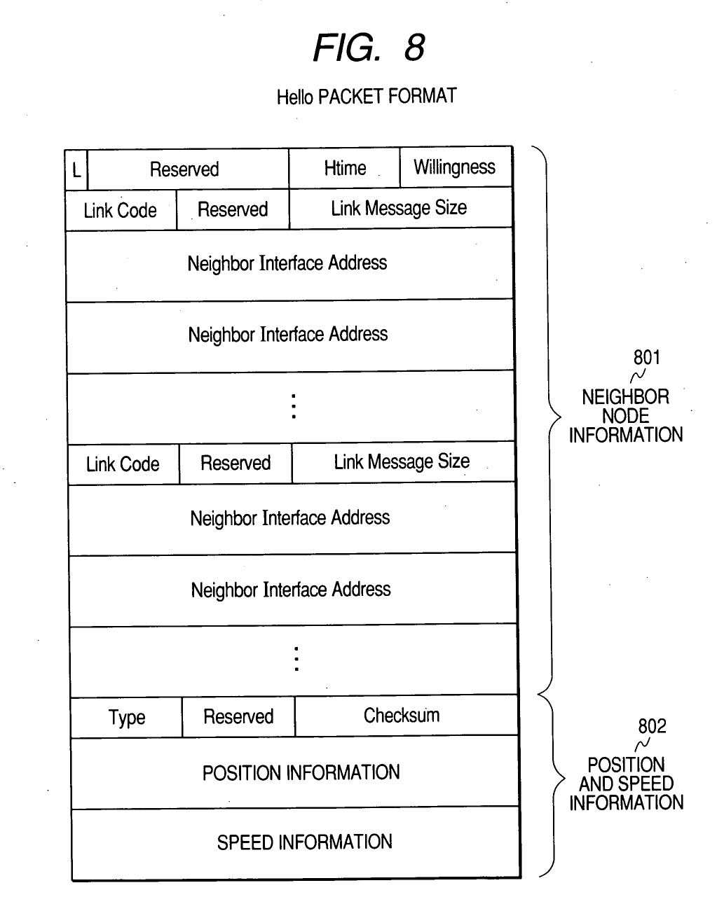

FIG. 8 shows an example of the Hello message containing the position and speed information.

An L bit is placed in the flag to show there is position and speed information. The communication area information management process 225 performed by the base station 101 is described next. The communication area information management process 225 is a process for forming the radio wave map 222. The Hello message receive history 221 is retained in order to form the radio wave map 222.

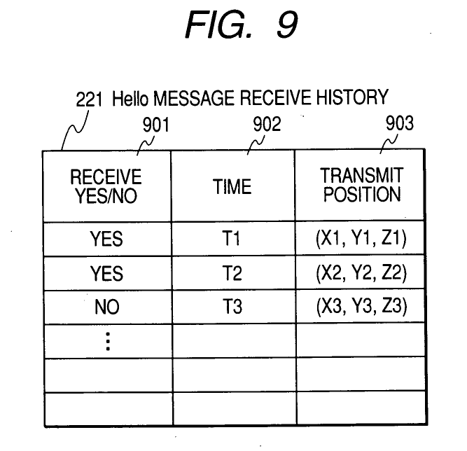

FIG. 9 shows an example of the Hello message receive history 221. The Hello message receive history 221 includes a receive Yes/No 901, time 902, transmit position 903.

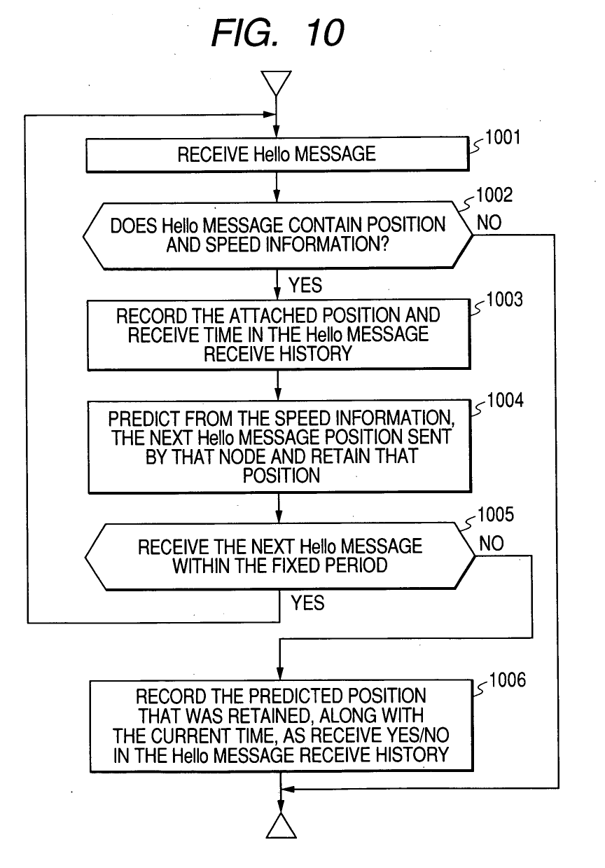

The process for forming the Hello message receive history is shown in FIG. 10. When the base station 101 receives the Hello message (step 1001), the position and speed information within the Hello message (step 1002) are checked. This process terminates if there is no position and speed information. If the Hello message does contain position and speed information then the attached position and receive time are recorded into the Hello message receive history 221 (step 1003), and the position that the node will next send the Hello message is estimated from the speed information and is retained (step 1004). The process is again repeated from step 1001 when the next Hello message is received within a fixed time from the applicable node (step 1005). If the next Hello message from the applicable node is not received within a fixed time then (step 1005), then the current time and the (retained) estimated position are recorded into the Hello message receive history 221 as impossible to receive (step 1006).

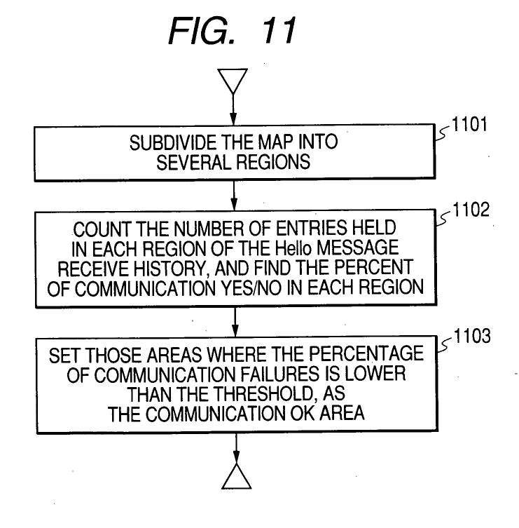

The process flow for forming the radio wave map 222 is shown in FIG. 11. In this process, a map centering on the base station 101 is subdivided into several areas (step 1101). The number of Hello message receive history 221 entries are counted and the percentage of communication failures for each area is found (step 1102). An area where the percentage of communication failures is smaller than a threshold is set as a communication-capable area (step 1103). Methods for forming the radio wave map include a method for forming the map only one time after the base stations are installed; and a method for periodically updating the map.

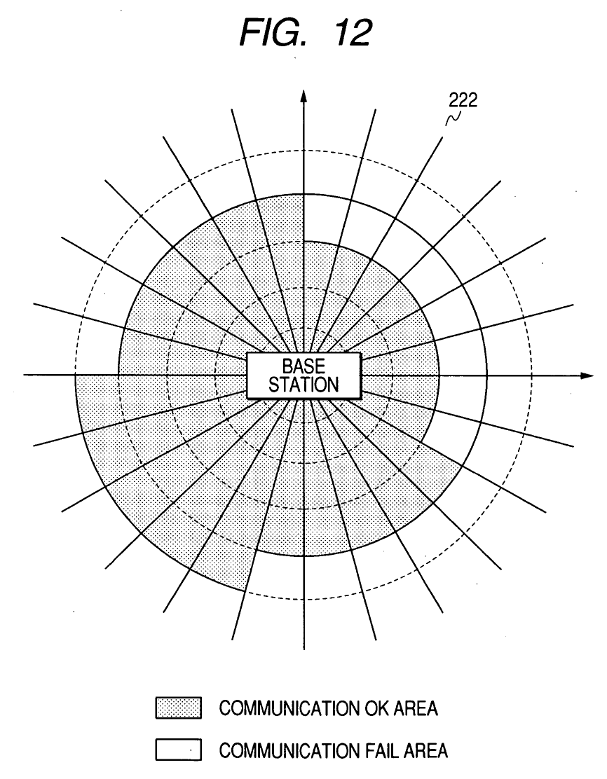

An example of the radio wave map 222 is shown in FIG. 12. One method for subdividing the radio wave map 222 area is to group the areas into a lattice in the shape of the radiations of that area. When one communication-failure area is discovered, then the areas along and beyond the radiation from that area become communication-failure areas.

This invention can be utilized to construct a service for providing a communication system for mobile nodes. This invention for example will prove effective in systems with many nodes and frequent movement such as communication network systems for cars.

What is claimed is:

1. An ad hoc network system for carrying out two-way communication by ad hoc type wireless communication, wherein
a communication node contains a management means for managing its own communication area information, detects movement to outside its own node communication area from position and speed information sent periodically from another communication node, and changes over in advance to communication via a third node present with the node's own communication area.

2. An ad hoc network system according to claim 1, wherein
when a communication node party detects movement of the other communication node party to outside its own communication area, that communication node utilizes a Hello message to notify the other communication node party to switch the communication path.

3. An ad hoc network system according to claim 1, wherein
a communication area information management means collects position information sent from a node and forms a map of regions where a specified number of information accumulated within a certain time are set as areas capable of communication.

4. A communication area information management means according to claim 3, wherein
after receiving a Hello message containing position and speed information from a node, when no Hello message was afterwards received from the same node within a specified time, the movement destination is predicted from the position and speed information in the original Hello message, and that predicted geographical point is recorded in the map as an unstable communication area.

5. A communication area information management means according to claim 4, wherein
by making the communication area map a lattice map of the radiation contour, when one unstable communication area is discovered, a map is then formed in which areas along and beyond the radiating shaped lattice are unstable communication areas.
